(19) United States
(12) Patent Application Publication
(10) Pub. No.: US 2024/0429861 A1
(43) Pub. Date: Dec. 26, 2024

(54) SOLAR PANEL WITH INDICATORS

(71) Applicant: FJP Solution LLC, Chino, CA (US)

(72) Inventor: Fang LU, Chino, CA (US)

(21) Appl. No.: 18/211,980

(22) Filed: Jun. 20, 2023

(51) Int. Cl. H02S 50/10; H02S 20/32

(52) U.S. Cl. CPC H02S 50/10; H02S 20/32; H02J 7/0047

(57) ABSTRACT

A solar-powered light is disclosed. The solar powered light includes: a solar panel configured to convert solar energy to electric current; a sensor configured to measure an electric current being generated by the solar panel; an indicator having at least two settings; a processor connected to the sensor, the processor configured to receive information from the sensor, the information comprising the electric current being generated by the solar panel, and control the indicator in response to the information by setting the indicator to one of the two settings.

### FIELD

This relates generally to a solar panel that can be used for powering an electronic device such as a light, and more particularly, to a solar panel that can indicate its real-time charging/discharging status and/or automatically adjust its direction to achieve the maximum power output.

### BACKGROUND

Solar powered lights and other electronic devices can be powered by solar power captured by one or more solar panels. Existing solar panels do not have a way of indicating their real-time charging/discharging status. In addition, they are usually set up to face a particular direction, which may not always be the optimal direction for getting charged by sunlight.

### BRIEF DESCRIPTION OF THE DRAWINGS

FIG. 1 illustrates the exemplary components of a solar panel, according to an embodiment of the disclosure.

FIG. 2a shows an exemplary solar panel including 3 indicating lights, according to an embodiment of the disclosure.

FIG. 2b shows an exemplary solar panel including a meter for indicating charging rate of a solar panel, according to an embodiment of the disclosure.

FIG. 3 illustrates the exemplary components of another solar panel, according to an embodiment of the disclosure.

FIG. 4a illustrates an exemplary mechanism for rotating a solar panel, according to an embodiment of the disclosure.

FIG. 4b illustrates an exemplary mechanism for rotating/tilting a solar panel, according to another embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

In one aspect, this generally relates to a solar panel that includes indicator(s) that can indicate whether the solar panel is facing an optimal direction for receiving sunlight and/or whether the solar panel is draining power faster than being charged by the sun.

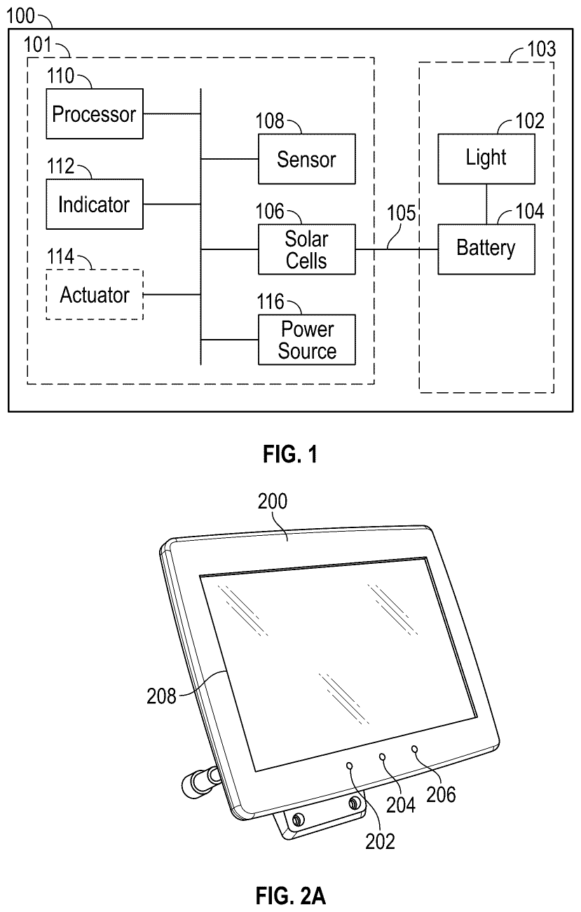

FIG. 1 illustrates the exemplary components of a solar panel connected to a light powered by the solar panel, according to a first embodiment of the disclosure. The solar-powered light 103 includes a light 102 connected to a battery 104, which is connected to and charged by a solar panel 101. The solar panel 101 includes solar cell(s) 106 that can receive light and convert it into energy to be stored by the battery 104 for powering the light 102. The solar panel 101 also includes a light sensor 108 that can detect the intensity of the sunlight. The intensive can be used for determining whether the solar panel 101 is facing an optimal direction for receiving sunlight. That is, when the detected intensity is at the highest, it can be determined that the solar panel 101 is facing the optimal direction for receiving sunlight.

A processor 110 is connected to the light sensor 108 and receives from the sensor 108 information (e.g., intensive of the light received by the solar cells 106) that can be used for determining whether the solar panel 101 is facing the optimal direction. In some embodiments, the processor 110 can also use information such as the time of the day, the location of the solar panel, and/or the direction of the light sensor 108 for determining whether the solar panel 101 is in the optimal direction for receiving sunlight.

In an alternative embodiment, the solar panel 101 can include a sensor for measuring the electric current being generated by the solar panel 101. The amount of electric current can also be used by the processor to determine whether the solar panel 101 is facing the optimal angle for receiving sunlight.

The processor 110 is also connected to an indicator 112 that can indicate how optimal the angle at which the solar panel 101 is for receiving sunlight. The processor 110 controls the indicator 112 in response to information received from the sensor 108.

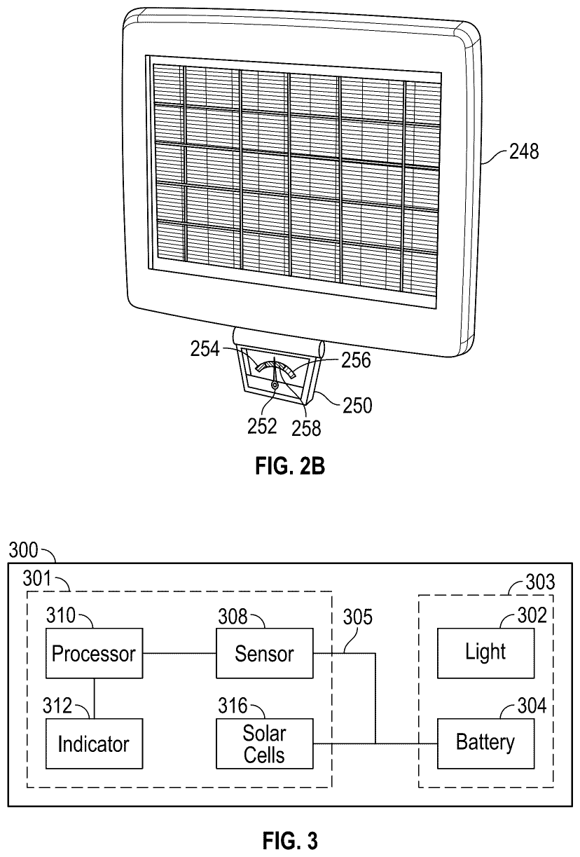

In one embodiment, the indicator 112 can be a set of lights. For example, as illustrated in FIG. 2a, the solar panel 200 can include a set of three lights 202, 204, 206. When the processor determines that the solar cells 208 of the solar panel 200 are receiving the maximum amount of sunlight (e.g., when facing the optimal direction for receiving sunlight, the processor (not shown in FIG. 2) can set all three lights 202, 204, 206 to the “on” state. If the processor determines that the solar cells 208 are receiving sunlight at about ⅔ of their full capacity, the processor can set two of the three lights 202, 204, 206 on and the other one off. If the processor determines that the solar cells 208 are receiving sunlight at about ⅓ about their full capacity, the processor can set one of the three lights 202, 204, 206 on and the other two off. If the processor determines that the solar cells 208 are not receiving any sunlight, the processor can set all three lights 202, 204, 206 to the “off” state.

It should be understood that the indicator does not necessarily need to be a set of three lights as shown on the solar panel 200 of FIG. 2a. In the embodiment shown in FIG. 2b, the indicator is a meter 250 with a needle 252 that indicates the charging rate by the solar panel 248. When the solar panel 248 is generating a large amount of current from the solar energy, the needle 252 is in the green zone 254. When the solar panel 248 is generating a small amount of current, the needle 252 is in the red zone 256. The orange zone 258 can correspond to an average amount of current being generated. In turn, the position of the needle 252 in the meter 250 can indicate whether the solar panel 248 is facing an optimal direction for receiving sunlight.

In another embodiment, the indicator can be a single light with variable brightness that can correspond to the amount of sunlight received by the solar panel. In yet another embodiment, the indicator can show different colors or include multiple lights of different colors to indicate different amounts of sunlight received by the solar cells of the solar panel. In yet another embodiment, the indicator can be a display that displays at what percentage the solar panel is being utilized for capturing sunlight.

Referring again to FIG. 1, additionally, the solar panel 101 can also include an actuator 114 that can tilt and/or turn the solar panel 101 so as to adjust the direction in which the solar panel 101 is facing. The actuator 114 can be powered by battery 104 or a local power source 116 and controlled by the processor 110. For example, the processor 110 can determine that the solar cells 106 are not receiving the maximum amount of sunlight based on information provided by the sensor 108. The processor 110 can then send a control signal to the actuator 114 to turn and/or tilt the solar panel (i.e., solar cells 106) in different directions. In one embodiment, the processor 110 can receive real time signal from the sensor 108 as it controls the actuator 114 to turn the solar cells 106. When the processor 110 determines based on the sensor information that the solar cells 106 are receiving the maximum amount of sunlight, it can stop the actuator 114 from further moving the solar cells 106. This will essentially set the solar panel 101/solar cells 106 in the optimal direction for receiving the most amount of sunlight.

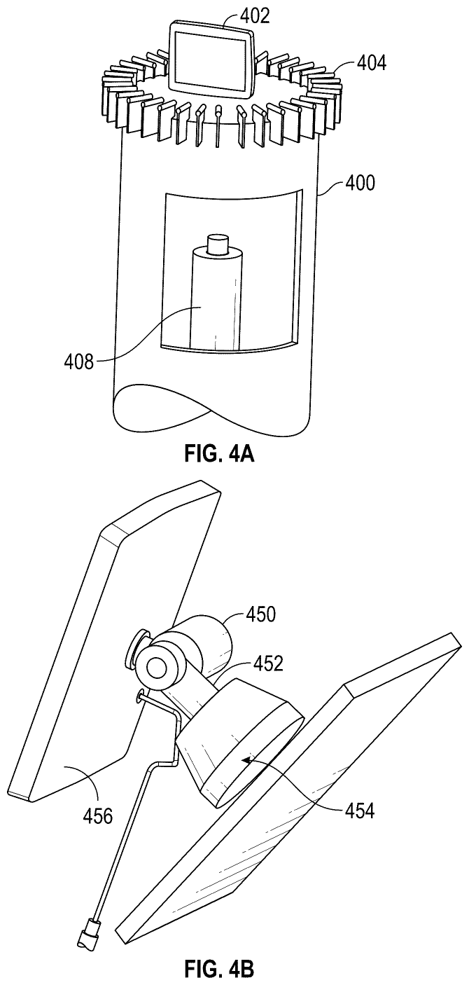

FIG. 4a illustrates an exemplary mechanism 400 for moving a solar panel 402. In this example, the mechanism 400 for moving the solar panel includes a drive plate rotating mechanism 404 that can rotate the solar panel 402 set on top of the drive plate rotating mechanism 404. The drive plate rotating mechanism 404 can be actuated by an actuator 408, which can be controlled by a processor (not shown in FIG. 4a) as described above.

FIG. 4b illustrates another exemplary mechanism for tilting/rotating a solar panel 456. The mechanism includes a base 454, attached to which are two motors, a X-axis motor 452 for actuating the movement of the solar panel 456 along an X-axis and a Y-axis motor 450 for actuating the movement of the solar panel 456 along an Y-axis. The X-axis and the Y-axis can be perpendicular to each other. Both the X-axis motor 452 and the Y-axis motor 450 can be controlled by an actuator (not shown in FIG. 4b) in the base 454. The actuator can be powered by a battery or the solar panel 456.

In operation, after the motors 452, 450 are powered up, the solar panel 456 can be rotated 45 degrees upward along the Y-axis and 180 degrees along the X-axis. During the rotating of the solar panel 456, a sensor can periodically detect the maximum power output of the solar panel 456. A processor can then determine the position of the solar panel 456 at which the solar panel 456 achieved the maximum power output and set the solar panel 456 at that position by manipulating the motors 452, 450. Whenever the Y angle is determined, every hour, the energy board will rotate again in the X direction to lock the direction and angle of the maximum power to work. Whenever the Y-axis position (e.g., angle) is determined, every hour, the solar panel 456 can rotate again in the X direction every hour (or at a different time interval) to determine and be locked into the direction and angle where it can produce the maximum power output.

Referring again to FIG. 1, in one embodiment, the light 102 and battery 104 can be in one physical device 103 and the other components of the solar powered light 100 including the solar cells 106, sensor 108, processor 110, indicator 112, and actuator 114 can be in a separate physical device 101. The two physical devices can be connected to each other by a wire 105 or other suitable means. In other embodiments, the light 102 can be substituted with other types of electronic devices that can be powered by the solar panel 101.

In another embodiment, all of the components of 101 and 103 of FIG. 1 can be in the same physical device 100.

FIG. 3 illustrates the exemplary components of another solar powered light 300, according to another embodiment of the disclosure. The solar powered light 300 of this embodiment includes a light 302 connected to a battery 304, which is connected to and charged by a solar panel 301. The solar panel 301 receives light via its solar cells 306 and converts light into energy to be stored by the battery 304 for powering the light 302. The solar panel 301 can also include a sensor 308 that can monitor the charging and discharging rates of the battery 304. A processor 310 is connected to the sensor 308 and receives information including the charging/discharging rates of the battery 304. The processor 310 is also connected to an indicator 312 that can indicate whether the light 302 is draining power from the battery 304 at a higher rate than the battery 304 is being charged by the solar panel 301.

In one embodiment, the light 302 and battery 304 can be in one physical device 303 and the other components of the solar powered light 300 including the sensor 310, solar cells 306, processor 310, and indicator 312 can be in a separate physical device 301, the two physical devices connected by a wire 305. The light 302 can be substituted by another electronic device that can be powered by the solar panel 301.

In one embodiment, the indicator 312 can include two lights. In operation, if the processor 310 receives information from the sensor 308 that indicates the discharging rate by the light 302 is higher than the rate at which the solar panel is being charged by sunlight (i.e., the overall rate of power consumption is greater than the charging rate of the solar panel), it can turn on the first light while keeping the second light off. In contrast, if the processor 310 receives information from the sensor 308 that indicates the discharging rate by the light 302 is lower than the rate of charging by sunlight (i.e., the overall rate of power consumption is less than the charging rate of the solar panel), the processor 310 can turn on the second light while keeping the first light off. It should be understood that other suitable indicator can be used for providing the same information.

It should be understood that the features of the embodiments illustrated in FIG. 1 and FIG. 2 can be combined in a single solar-powered device. For example, a solar-powered light can have two indicators to indicate, respectively, whether its solar panel is being charged at the maximum rate and whether the rate of power consumption by the light is lower than the rate of charging via the solar panel.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

1. A solar-powered device comprising:
a solar panel configured to convert solar energy to electric current;
a sensor configured to measure an electric current being generated by the solar panel;
an indicator having at least two settings;
a processor connected to the sensor, the processor configured to
receive information from the sensor, the information comprising the electric current being generated by the solar panel, and
control the indicator in response to the information by setting the indicator to one of the two settings; and
an actuator configured to rotate the solar panel along at least two axes.

2. The solar-powered device of claim 1, wherein the a first of the two settings indicates that the solar panel is generating a maximum electric current and a second of the two settings indicates that the solar panel is generating less than the maximum electric current.

3. The solar-powered device of claim 1, wherein the indicator comprises three lights and has four settings, a first setting comprising turning on all three lights to indicate a first level of electric current output, a second setting comprising turning on two of the three lights to indicate a second level of electric current output, a third setting comprising turning on one of the three lights to indicate a third level of electric current output, and a fourth setting comprising turning on none of the three lights to indicate a fourth level of electric current output.

4. The solar-powered device of claim 1, wherein the sensor comprises a light sensor configured to detect an intensity of light from the sun; and the processor is configured to determine whether the solar panel is facing an optimal direction based on the intensity of the light.

5. The solar-powered device of claim 1,
wherein the processor is connected to the actuator and further configured to control the actuator based on information provided from the sensor.

6. The solar-powered device of claim 5 wherein the processor is configured to control the actuator by set the solar panel to a position at which the information provided the sensor indicates a maximum level of electric current output by the solar panel.

7. The solar-powered device of claim 1 further comprising a first motor and a second motor, each of the first and second motors configured to rotate the solar panel along a respective axis.

8. A solar-powered light comprising:
a solar panel configured to charge a battery;
a sensor configured to monitor charging and discharging rates of the solar panel;
an indicator having at least two settings;
a processor connected to the sensor, the processor configured to
receive information from the sensor, the information indicating whether the solar panel is charging the battery at a higher rate than the battery is being discharged to power the solar-powered light, and
control the indicator in response to the information.

9. The solar-powered device of claim 8, wherein the a first of the two settings indicates that the solar panel is charging the battery at a higher rate than the battery is being discharged to power the solar-powered light and a second of the two settings indicates that the solar panel is charging the battery at a lower rate than the battery is being discharged to power the solar-powered light.

10. The solar-powered device of claim 9, wherein the indicator comprises two lights and the first setting comprises turning on only a first of the two lights and the second setting comprises turning on only a second of the two lights.

11. The solar-powered device of claim 8, wherein the sensor is configured to monitor the charging and discharging rates of the solar panel by sensing current going in and out of the solar panel.
